(19) United States
(12) Patent Application Publication
(10) Pub. No.: US 2008/0098443 A1
(43) Pub. Date: Apr. 24, 2008

(54) Apparatus and Method for Activating an Interactive Application

(75) Inventors: Liang Gan, Shanghai (CN); Jun Shi, Shanghai (CN); Jingwei Tan, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,945

(22) PCT Filed: Jul. 4, 2005
(86) PCT No.: PCT/IB05/52206

§ 371 Date: Jan. 11, 2007

(30) Foreign Application Priority Data
Jul. 15, 2004 (CN) 200410054412.X

(51) Int. Cl. H04N 7/173; H04N 5/00

(52) U.S. Cl. 725/100; 725/61; 725/105; 725/131; 725/139; 386/124

(57) ABSTRACT

An activating apparatus (300) is arranged to conditionally activate an interactive application associated with a digital program. The activating apparatus (300) has a receiving means (310) for receiving program information of the digital program and application information regarding the interactive application, a detecting means (320) for detecting a program mode of the digital program, the program mode indicating how the digital program is being run, and an obtaining means (330) for obtaining an activating parameter from the application information, the activating parameter indicating the interactive application has at least two mutually different portions, at least one of the at least two portions is conditionally be executed in dependency on the application including an the program mode. with the program mode.

### FIELD OF THE INVENTION

The invention relates to a method of associating an interactive application to a digital program, the method comprising: receiving a plurality of settings of the interactive application, generating the interactive application with the settings, and associating the generated interactive application to the digital program.

The invention further relates to a method of activating an interactive application associated with a digital program, the method comprising: receiving program information of the digital program and application information regarding the interactive application, and detecting a program mode of the digital program, the program mode indicating how the digital program is being run.

The invention further relates to an activating apparatus for activating an interactive application associated with a digital program, the apparatus comprising: receiving means for receiving program information of the digital program and application information regarding the interactive application, and detecting means for detecting a program mode of the digital program, the program mode indicating how the digital program is being run.

The invention further relates to a set-top box for activating an interactive application associated with a digital program, the set box comprising: a receiver for receiving the digital program associated with the interactive application.

The invention further relates to a television set for activating an interactive application associated with a digital program, the television set comprising: a receiver for receiving the digital program associated with the interactive application and a display for displaying the digital program.

The invention further relates to a digital recorder for storing a digital program and activating an application associated with the digital program, the digital recorder comprising: a receiver for receiving the digital program associated with the interactive application, storing means for storing the digital program and conditionally storing the interactive application on a storage medium, and retrieving means for retrieving the digital program associated with the interactive application from the storage medium.

The invention further relates to a computer program product for activating an interactive application associated with a digital program, the computer program product comprising: code for receiving program information of the digital program and application information regarding the interactive application, and code for detecting a program mode of the digital program, the program mode indicating how the digital program is being run.

The invention further relates to a storage carrier containing such a computer program product.

### BACKGROUND OF THE INVENTION

The invention further relates to an interactive application associated with a digital program. PCT patent application with publication number WO 01/33852 A1 describes a system and method for recording a pushed data stream, which is broadcast to a receiving station, wherein the pushed data stream includes one or more data objects. The data stream may also refer to live data objects which are intended for immediate consumption and become obsolete thereafter.

The data stream in the above mentioned PCT patent application may include a file table and object properties corresponding to the data objects. When the data stream is received by the receiving station, the individual data objects are extracted from the data stream, then the data objects, accompanying object properties and the file table are stored on a storage device, wherein live data objects are not stored, but references to these live data objects are stored, so that when the program is replayed, current versions of the referenced live data objects can be used.

### OBJECT AND SUMMARY OF THE INVENTION

It is an object of the invention to provide a method of associating an interactive application to a digital program offering a more flexible mechanism of associating the interactive application with the digital program. This object is achieved according to the invention in a method that is characterized in that one of the settings is an activating parameter, indicating the interactive application is only to be activated when the digital program is non-live played.

It is to be noted that the application modes used in the method known from PCT patent application with publication number WO 01/33852 A1 include “live only” and “live & Storage”, where “live only” means the application is intended for immediate consumption when the program is live played, and “live & Storage” means the application is to be activated regardless whether the program is live played or non-live played.

According to the present invention there is one more application mode that is “storage only”. “storage only” means the application is to be activated only when the program is non-live played. An example of “storage only” application is an application of “Quiz” in a multimedia tele-education program where this application only can be available for the student after he/she has stored this program. In this circumstance, during the live play of the program the student cannot access this “storage only” application, therefore he/she can concentrate on the teacher's speech and cannot disturb the teacher's schedule.

By using an activating parameter that indicates the application is only to be activated when the program is non-live played, the application modes become more abundant, and the program maker has more choices for the applications.

It is a further object of the invention to provide another method of associating an interactive application to a digital program offering a more flexible mechanism of associating the interactive application with the digital program. This object is achieved according to the invention in a method that is characterized in that one of the settings is an activating parameter, indicating the interactive application has at least two mutually different portions, and that at least one of the at least two portions is conditionally executed in dependency on a program mode, the program mode indicating how the digital program is being run.

It is also to be noted that the application mode used in the method known from PCT patent application with publication number WO 01/33852 A1 is applied to the whole application.

According to the present invention there are at least two portions of the application, which is called as a “hybrid” application herein, and at least one portion has a different portion mode than the other portion(s). An example of a “hybrid” application is an application of “Exercise” in a multimedia tele-education program, which includes 30 pieces of exercises, where 20 exercises of this application are only available for the student after he/she has stored this program, and the rest of the exercises of this application is only available for the student when the program is live played. In other words, the portion mode of the 20 exercises is “storage only”, and the portion mode of the rest of the exercises is “live only”. In this circumstance, during the live play of the program the student can only access this “live only” portion of the application, therefore he/she can concentrate on the teacher's speech and will not disturb the teacher's schedule.

By using an activating parameter that indicates the application has at least two portions, wherein at least one of the at least two portions is to be executed in dependency on the program mode, and at least one portion has a different portion mode than the other portion(s), a new kind of application has been created. The application mode of this application is hybrid. Therefore, the application modes become more abundant, and the program maker has more choices for the applications.

An embodiment of the method according to the invention is described in claim 3. In such an environment, the application has at least two portions, and at least one of the at least two portions is to be executed only when the program is non-live played, which means that during the live play of the program, this portion can not be executed.

An embodiment of the method according to the invention is described in claim 4. In such an environment, the application has at least two portions, and at least one of the at least two portions is to be executed only when the program is live played, which means that during the non-live play of the program, this portion can not be executed.

It is a further object of the invention to provide a method of activating an interactive application associated with a digital program offering a more flexible mechanism of activating the interactive application with the digital program. This object is achieved according to the invention in a method that is characterized in that the method has the step of obtaining an activating parameter from the application information, and that the activating parameter indicates the application is only to be activated when the program is non-live played.

By using the activating parameter, during live play of this program, at the receiving end, the application can be scheduled only for a storage purpose instead of being presented to the viewer, and further when this program is played in a “non-live played” mode, this application is to be activated and presented to the viewer.

An example of this invention is when the receiver receives an application of “Quiz” in a multimedia tele-education program with an activating parameter “storage only”. If the program is live played, the receiver will send this application for storage instead of presenting it to the student, and if the program is non-live played, the receiver will present this application to the student.

It is a further object of the invention to provide another method of activating an interactive application associated with a digital program offering a more flexible mechanism of activating the interactive application with the digital program. This object is achieved according to the invention in a method that is characterized in that the method has the step of obtaining an activating parameter from the application information, the activating parameter indicates the interactive application has at least two mutually different portions, at least one of the at least two portions is conditionally executed in dependency on the program mode.

The method according to the invention makes it possible to provide different criteria to different portions of the application, so that the different portions will be executed in different program modes.

An example of this invention is when the receiver receives an application of “Exercise” in a multimedia tele-education program with an activating parameter “hybrid”. If the program is live played, the receiver will block “storage only” portion of this application form presenting, and present “live only” portion of this application to the students.

It is a further object of the invention to provide an apparatus according to the preamble offering a more flexible mechanism of activating the interactive application with the digital program. This object is achieved according to the invention in an apparatus that is characterized in that the apparatus further comprises obtaining means for obtaining an activating parameter from the application information, the activating parameter indicates the interactive application has at least two mutually different portions, at least one of the at least two portions is conditionally executed in dependency on the program mode.

In the activating apparatus according to the invention, when the application is received, the activating parameter of the application is acquired, which indicates that the application has at least two portions, then the application is sent to a launchable list of an application manager, and each portion of the application will be processed according to the program mode, so the program maker has more control on this application.

A set-top box according to the invention is achieved in that the set-top box according to the preamble further comprises an activating apparatus for activating the interactive application associated with the digital program as claimed in claim 13.

A television set according to the invention is achieved in that the television set according to the preamble further comprises an activating apparatus for activating the interactive application associated with the digital program as claimed in claim 13.

A digital recorder according to the invention is achieved in that the digital recorder according to the preamble further comprises an activating apparatus for activating the interactive application associated with the digital program as claimed in claim 13.

It is a further object of the invention to provide a computer program product according to the preamble offering a more flexible mechanism of activating the interactive application with the digital program. This object is achieved according to the invention in a computer program product that is characterized in that the computer program further comprises code for obtaining an activating parameter from the application information, the activating parameter indicates the interactive application has at least two mutually different portions, at least one of the at least two portions is conditionally be executed in dependency on the program mode.

It is a further object of the invention to provide an interactive application associated to a digital program, the interactive application comprising: at least two portions containing code, code for detecting a program mode of the digital program, the program mode indicates how the digital program is being run, code for conditionally executing at least one portion of the application in dependency on the program code.

In the interactive application according to the invention, there are at least two portions. When the application is running, each portion of the application will be processed according to the program mode, so the program maker has more control on this application.

### BRIEF DESCRIPTION OF THE DRAWINGS

The invention and its attendant advantages will be further elucidated with the aid of exemplary embodiments and the accompanying schematic drawings, wherein:

FIG. 1 shows a flow chart of associating an interactive application to a digital program according the invention,

FIG. 2 schematically shows an interactive application according to the invention,

FIG. 3 schematically shows the most important components of an activating apparatus according to the invention,

FIG. 4 schematically shows a set-top box according to the invention,

FIG. 5 schematically shows a television set according to the invention, and

FIG. 6 schematically shows a digital video recorder according to the invention.

Corresponding features in the various Figures are denoted by the same reference symbols.

### DETAILED DESCRIPTION OF THE INVENTION

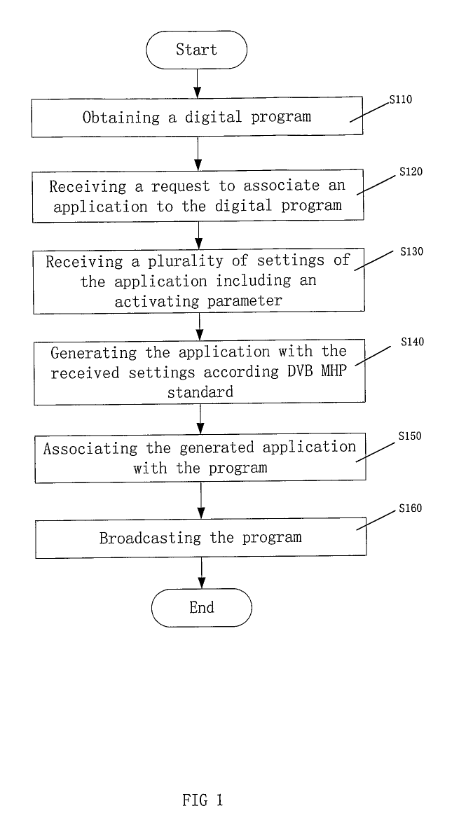

FIG. 1 shows a flow chart of associating an interactive application to a digital program according the invention. Herein the interactive application does not mean this application shall be run with the involvement of the user of the digital program, but under some circumstances the interactive application can be run by itself. For example, a certain event such as a goal of a football match can trigger an interactive application presenting the introduction of the sportsman of the goal.

The digital program may contain an audio part, a video part and a data part. Compared to the interactive application, the audio, video and data part are played in a passive way for the user. In the DVB (Digital Video Broadcasting) standard, the digital program may contain zero or more video sub-streams, that is MPEG PES (Motion Picture Experts Group Packetized Elementary Stream), zero or more audio sub-streams, zero or more data sub-streams and service information. An extreme example of the digital program is that a digital program only contains service information.

The interactive application in the DVB MHP (Multimedia Home Platform) standard is encoded in the private sections as the state of modules and multiplexed into a transport stream. The modules making up a carousel will be broadcast repeatedly. In addition, the DVB MHP standard defines an application information table (AIT) in the private section as shown below, which is used to provide the related information of the application. This AIT table is also broadcast repeatedly and the minimum repetition rate for each AIT table is 10 seconds.

TABLE 1
Syntax of AIT

| | No. Of | |
|---|---|---|
| Syntax | bits | Mnemonic |
| application_information_section( ){ | | |
| table_id | 8 | uimsbf |
| section_syntax_indicator | 1 | bslbf |
| Reserved_future_use | 1 | bslbf |
| Reserved | 2 | bslbf |
| section_length | 12 | uimsbf |
| application_type | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| Reserved_future_use | 4 | bslbf |
| Common_descriptors_length | 12 | uimsbf |
| for (i=0; i<N; i++) { | | |
| descriptor( ) | | |
| } | | |
| Reserved_future_use | 4 | bslbf |
| application_loop_length | 12 | uimsbf |
| for(i=0;i<N;i++){ | | bslbf |
| application_identifier( ) | | |
| application_control_code | 8 | bslbf |
| reserved_future_use | 4 | uimsbf |
| application_descriptors_loop_length | 12 | |
| For(j=0;j<N;j++){ | | |
| descriptor( ) | | |
| } | | |
| } | | |
| CRC_32 | 32 | rpchof |
| } | | |

There is a field named “application_control_code” listed in the above AIT table, which is used to dynamically control the life cycle of the interactive application. The interactive application may have 4 types of different application control code:

autostart , the application is automatically started;

present, the application can be started by the user, but not started automatically

destroy, the application is requested to kill itself

kill, the application is unconditionally killed

All the applications are started and stopped by an application manager, and there is a launchable list of the applications managed by the application manager.

According to the invention, an application category of 4 application modes is introduced as follows:

live only, the application is to be activated only when the program is live played,

storage only, the application is to be activated only when the program is non-live played,

live & storage, the application is to be activated regardless how the digital program is being run,

hybrid, the application has at least two mutually different portions, at least one of the at least two portions is conditionally executed in dependency on a program mode, the program mode indicating how the digital program is being run. The hybrid application will be further elucidated in details.

The application mode is added as an activating parameter to the interactive application. For example, in the DVB MHP standard, the activating parameter of application mode is defined as a descriptor in AIT (see italics field in table 1). In an embodiment of the invention, the syntax of application mode descriptor is defined as shown in table 2, and the semantics of application mode values is defined as shown in table 3.

TABLE 2
Syntax of application mode descriptor

| | No.of Bits | Identifier |
|---|---|---|
| application_mode_descriptor( ) { | | |
| descriptor_tag | 8 | uimsbf |
| descriptor_length | 8 | uimsbf |
| Application_mode | 8 | uimsbf |
| reserved | 8 | bslbf |
| } | | |

TABLE 3
Semantics of applciation mode values

| Application_mode | Property |
|---|---|
| 0 | live & storage |
| 1 | live only |
| 2 | Storage only |
| 3 | Hybrid |
| 4 to 255 | reserved |

The difference between the application mode according to the invention and the application control code is that the application mode is mainly to determine whether the interactive application is to be activated, that is sent to the application launchable list in dependency on the program mode, while the application_control_code is to control the lifecycle of the application listed in the application launchable list.

It should be noted that the application modes may have more choices which may use a number between 4 to 255. Furthermore, the application mode may be added to other areas in the AIT than in the descriptor, for example, in one of the reserved fields in the AIT.

It should be further noted that the activating parameter of the application mode could be associated to the digital program in other ways as long as the application mode can be extracted when the digital program is being played/stored.

The above-mentioned program mode has two types, “live played” and “non-live played”.

The program mode is detected by the source of the digital program. If a program is received from a tuner, it is live played; and if a program is received form a storage medium, it is non-live played.

The detection of program mode may also be achieved by detecting a program property associated with the digital program, and the program property of the program mode indicates how the program is being run. For example, in the DVB standard, the program property of the program mode may be introduced as a descriptor in the PMT (Program Mapping Table). When a program is being made, its program property of the program mode is set to “live played”, and when a program is being broadcast and recorded, during the recording process the program property of the program mode is set to “non-live played”.

The flow chart of FIG. 1 shows how to associate an interactive application to a digital program according to the invention. This process can be completed by one of the various current program making tools, such as Coral MHP.

First, a digital program is obtained (Step S110). The digital program may contain some A/V or data sub-streams as described above and service information.

Secondly, a request to associate an interactive application to the digital program is received (Step S120), and a plurality of settings of the interactive application is received (Step S130). One of the settings is an activating parameter, which indicates the interactive application is to be activated conditionally in dependency on how the digital program is being run.

The activating parameter indicates one of the application modes defined above. For example, the application mode value of the activating parameter is 2 which means its application mode is “storage only”. The “storage only” interactive application is only to be activated when the digital program is non-live played and is not to be activated when the digital program is live played. An example of this invention is when the receiver receives an application of “Quiz” in a multimedia tele-education program with an activating parameter “storage only”. If the program is live played, the receiver should ignore this application if the program is not being recorded, or send this application for storage instead of presenting it to the student if the program is being recorded. And if the program is non-live played, the receiver should present this application to the student.

Thirdly, the application with the received setting according the DVB MHP standard is generated (Step S140), and the generated application with the digital program is associated (Step S150). The content of the application is in one or more files in a module, which is finally multiplexed into the private sections, the related property information such as the activating parameter is in the AIT associated to the digital program.

It should be noted that the generating and associating process could be achieved in accordance with other current or future digital program making technology.

Finally, the digital program is broadcast (Step S160). It may be a satellite broadcast, a terrestrial broadcast or a cable broadcast.

FIG. 2 schematically shows an interactive application according to the invention. The interactive application is “hybrid”, which indicates the interactive application has at least two mutually different portions. One of the two portions is conditionally executed in dependency on a program mode, whereby the program mode indicates how the digital program is being run. The application mode value of the activating parameter is 3 as described in the above table 3.

The interactive application 200 has two portions, the first portion 230 and the second portion 240. The first portion 230 has a portion mode “live only” which indicates this portion is only executed when the program is live played, and the second portion 240 has a portion mode “storage only” which indicates this portion is only executed when the program is non-live played.

An example of a “hybrid” application is an application of “Exercise” in a multimedia tele-education program, which includes 30 pieces of exercises, where 20 exercises of this application are only available for the student after he/she has stored this program, and the rest of the exercises of this application is only available for the student when the program is live played. In other words, the portion mode of the 20 exercises is “storage only”, and the portion mode of the rest of the exercises is “live only”. In this circumstance, during the live play of the program the student can only access this “live only” portion of the application, therefore he/she can concentrate on the teacher's speech and will not disturb the teacher's schedule.

It should be noted that the “hybrid” interactive application may have more than 2 portions, and the portion mode of each portion could be one of the following 3 types: “live only”, “storage only” and “live & storage”, which have similar meaning with the application mode as described above, for example, “live & storage” portion mode indicates this portion is to be executed regardless how the program is being ran. One embodiment of the “hybrid” interactive application is that all the portions do not have the same portion mode.

The interactive application 200 also has code 210 for detecting the program mode of the digital program, the program mode indicating how the digital program is being run, and code 220 for conditionally executing at least one portion of the application in dependency on the program mode.

When the interactive application 200 is being run in a set-top box, code 210 can get the program code form the middleware of the set-top box. For example, the program mode is “non-live played”, and then code 220 determines to run the portion 240 according to the results of executing code 210. The following is an exemplary frame of the hybrid interactive application based on Java language:

```
...
  main( )
  {
    int runningMedia=getCurrentLocation( );
    ...
    run Live&StorageLoop;
......
    if (runningMedia is Non-live Played)
  {
    run StorageOnlyPart;
  }
... ...
  if (runningMedia is Live Played)
  {
    run LiveOnlyPart;
  }
... ...
```

The order of the portion of code showed in FIG. 2 may be changed, as long as code 210 is first executed and code 220 is second executed.

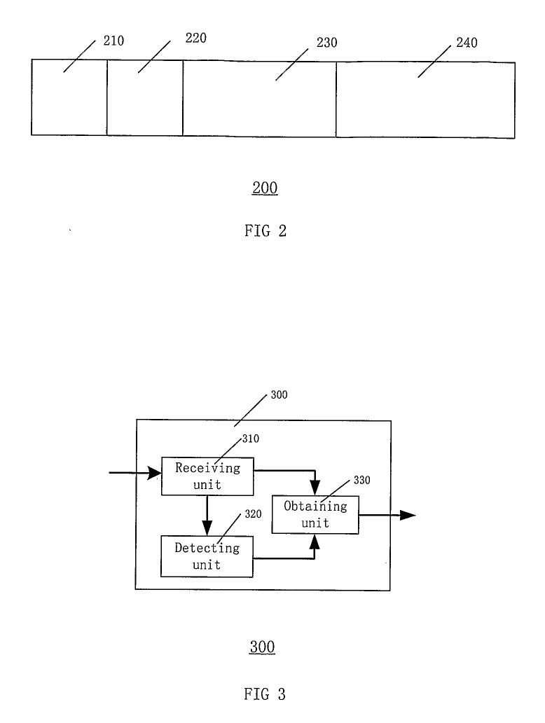

FIG. 3 schematically shows the most important components of an activating apparatus according to the invention. The activating apparatus 300 has a receiving means 310, a detecting means 320 and an obtaining means 330.

The receiving means 310 is used for receiving program information of the digital program and application information regarding the interactive application. An example is that the receiving means 310 receives a PMT of the digital program that include the program information of the digital program and an AIT that includes the application information of an interactive application, and the AIT includes an activating parameter as defined above.

The detecting means 320 is used for detecting the program mode of the digital program, the program mode indicating how the digital program is being run. When the receiving unit 310 is receiving program information of the digital program, the detecting means detects the program mode of the digital program. One alternative of such detection is to detect the source of the program: if the program is from a tuner, it is live played, and if the program is from a storage medium, it is non-live played. Another alternative of such detection as mentioned above is to detect the program property of program mode that has been associated to the digital program.

The obtaining means 330 is for obtaining an activating parameter from the application information, the activating parameter indicating the interactive application has at least two mutually different portions, at least one of the at least two portions is conditionally executed in dependency on the program mode.

An example is that the obtaining means 330 extracts the activating parameter from the AIT table received by the receiving means 310, and process this application in dependency on the program code detected by the detecting means 320. Some situations are elucidated as follows:

One situation is that the activating parameter obtained by the obtaining means 330 is “storage only” and the program mode detected by the detecting means 320 is “non-live played”. Then, the interactive application is activated, herein which means it is sent to the application launchable list.

Another situation is that the activating parameter obtained by the obtaining means 330 is “storage only” and the program mode detected by the detecting means 320 is “live played”. Then, the interactive application is sent to the storage medium if the program is being recorded, or the interactive application is ignored.

Still another situation is that the activating parameter obtained by the obtaining means 330 is “hybrid”. Then, the interactive application is activated, and herein which means it is sent to the application launchable list. The activating parameter “hybrid” indicates the interactive application has at least two portions that have different portion modes. When the “hybrid” application on the application launchable list is being run, different portions are executed depending on the program mode detected by the detecting means 320. If the program mode is “live played”, the portion(s) of “live only” will be executed. If the program mode is “non live played”, the portion(s) of “storage only” will be executed.

An example of this situation is an application of “Exercise” in a multimedia tele-education program, which includes 30 pieces of exercises, where 20 exercises of this application are only available for the student after he/she has stored this program, and the rest of the exercises of this application is only available for the student when the program is live played. In other words, the portion mode of the 20 exercises is “storage only”, and the portion mode of the rest of the exercises is “live only”. In this circumstance, during the live play of the program the student can only access this “live only” portion of the application, therefore he/she can concentrate on the teacher's speech and will not disturb the teacher's schedule.

It should be noted there could be more situations that have not been illustrated as above.

It should also be noted that not all the interactive applications on the application launchable list are to be run automatically, which still are to be determined in dependency on application_control_code.

The invention can also be implemented by means of a suitably programmed computer provided with a computer program for activating an interactive application associated with a digital program. The computer program product for activating an interactive application associated with a digital program comprises code for receiving program information of the digital program and application information regarding the interactive application, code for detecting a program mode of the digital program, the program mode indicates how the digital program is being run, and code for obtaining an activating parameter from the application information, the activating parameter indicates the interactive application has at least two mutually different portions, at least one of the at least two portions is conditionally to be executed in dependency on the program mode. Such a computer program product may be stored in a storage carrier.

These portions of program code may be provided to a processor to produce a machine, such that the code that executes on the processor create means for implementing the functions specified as above.

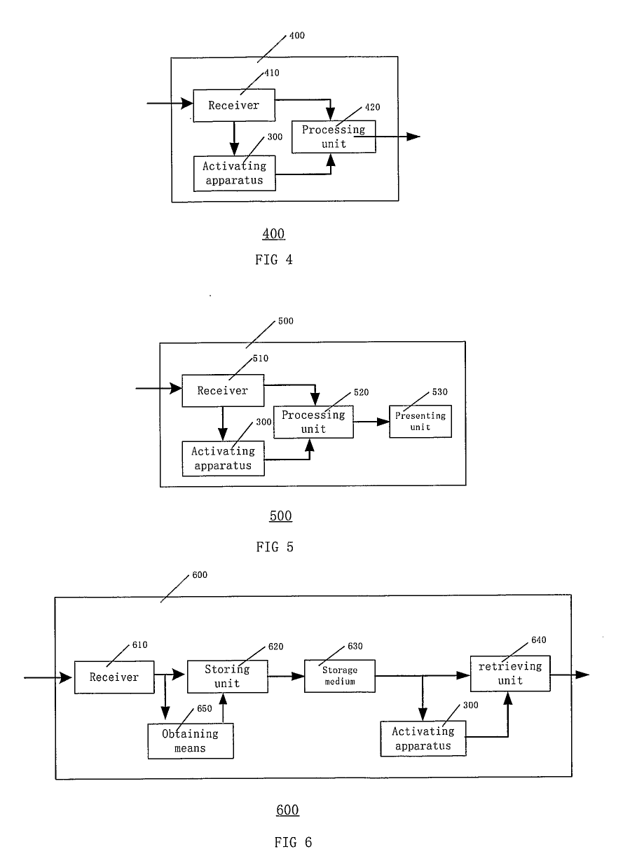

FIG. 4 schematically shows a set-top box according to the invention. The set-top box 400 contains a receiver 410 for receiving the digital program and the interactive application associated with the digital program. The digital program and the interactive application can be transmitted to the set-top box in one of various ways, such as by cable broadcast, by terrestrial broadcast or by satellite broadcast and etc. The received digital program and interactive application are processed in the set-top box with a processing unit 420 and subsequently sent out for display or recording. The set-top box 400 further contains an activating apparatus 300 as described above. The activating apparatus detects the program mode of the digital program received by the receiver 410, and obtains the activating parameter from application information of the interactive application received by the receiver 410, and then the activating apparatus controls the processing unit 420 for conditionally scheduling the interactive application. If the activating parameter is hybrid, at least one of the portions of the interactive application is to be conditionally executed in dependency on the program mode.

FIG. 5 schematically shows a television set according to the invention. The television set 500 contains a receiver 510 for receiving the digital program and the interactive application associated with the digital program. The digital program and the interactive application can be transmitted to the television set 500 in one of various ways, such as by cable broadcast, by terrestrial broadcast or by satellite broadcast and etc. The received digital program and interactive application are processed in the television set with a processing unit 520 to be displayed on a presenting unit 530, e.g. CRT. The television set 500 further contains an activating apparatus 300 as described above. The activating apparatus 300 detects the program mode of the digital program received by the receiver 510, and obtains the activating parameter form application information of the interactive application received by the receiver 510, and then the activating apparatus controls the processing unit 520 for conditionally scheduling the interactive application. If the activating parameter is hybrid, at least one of the portions of the interactive application is to be conditionally executed in dependency on the program mode.

FIG. 6 schematically shows a digital recorder according to the invention. The digital recorder 600 contains a receiver 610 for receiving the digital program and the interactive application associated with the digital program, The digital program and the interactive application can be transmitted to the digital recorder 600 in one of various ways, such as by cable broadcast, by terrestrial broadcast or by satellite broadcast and etc. The digital recorder 600 has a storing unit 620 for storing the digital program and the interactive application on a storage medium 630. This storage medium 630 is a hard disk, but other suitable media like a CD-RW may be used.

The digital recorder 600 optionally contains an obtaining means 650 that can extract the activating parameter of the interactive application. If the interactive application is stored in the mode of files, the interactive application with the activating parameter “live only” is blocked for storage, thus the obtaining means 650 control the storage unit 620 to conditionally store the interactive application by this blocking. If the interactive application is storing in mode of transport stream, it is no need for the obtaining means 650. The obtaining means 650 has the same function as the obtaining means 330 as described above.

Furthermore, the digital recorder 600 has a retrieving unit 640 for retrieving the digital program associated with the interactive application from the storage medium 630. The digital recorder 600 further contains an activating apparatus 300 as described above. The activating apparatus 300 detects the program mode of the digital program retrieved by the retrieving unit 640, and obtains the activating parameter from application information of the interactive application retrieved by the retrieving unit 640, and then the activating apparatus controls the retrieving unit 640 for conditionally scheduling the interactive application. If the activating parameter is hybrid, at least one of the portions of the interactive application is to be conditionally executed in dependency on the program mode.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

What is claimed is:

1. A method of associating an interactive application to a digital program, the method comprising:
receiving a plurality of settings of the interactive application,
generating the interactive application with the settings , and
associating the generated interactive application to the digital program,
characterized in that one of the settings is an activating parameter, indicating the interactive application is only to be activated when the digital program is non-live played.

2. A method of associating an interactive application to a digital program, the method comprising:
receiving a plurality of settings of the interactive application,
generating the interactive application with the settings, and
associating the generated interactive application to the digital program,
characterized in that one of the settings is an activating parameter, indicating the interactive application has at least two mutually different portions, and one of the at least two portions is conditionally to be executed in dependency on a program mode, the program mode indicates how the digital program is being run.

3. A method as claimed in claim 2, wherein one of the at least two portions is to be executed only when the program is non-live played.

4. A method as claimed in claim 2, wherein one of the at least two portions is to be executed only when the program is live played.

5. A method as claimed in claim 2, wherein the digital program is a digital TV program compliant with Digital Video Broadcasting standard.

6. A method of activating an interactive application associated with a digital program, the method comprising:
receiving program information of the digital program and application information regarding the interactive application, and
detecting a program mode of the digital program, the program mode indicating how the digital program is being run,
characterized in that the method has the step:
obtaining an activating parameter from the application information, the activating parameter indicating the application is only to be activated when the program is non-live played.

7. A method of activating an interactive application associated with a digital program, the method comprising:
receiving program information of the digital program and application information
regarding the interactive application, and
detecting a program mode of the digital program, the program mode indicates how the digital program is being run,
characterized in that the method has the step:
obtaining an activating parameter from the application information, the activating parameter indicating the interactive application has at least two mutually different portions, at least one of the at least two portions is conditionally to be executed in dependency on the program mode.

8. A method as claimed in claim 7, wherein the program mode is that the digital program is live played.

9. A method as claimed in claim 7, wherein the program mode is that the digital program is non-live played.

10. A method as claimed in claim 7, wherein the at least one of the at least two portions is to be executed only when the digital program is live played.

11. A method as claimed in claim 7, wherein the at least one of the at least two portions is to be executed only when the digital program is non-live played.

12. A method as claimed in claim 7, wherein the digital program is a digital TV program compliant with Digital Video Broadcasting standard.

13. An activating apparatus for activating an interactive application associated with a digital program, the apparatus comprising:
receiving means for receiving program information of the digital program and application information regarding the interactive application, and
detecting means for detecting a program mode of the digital program, the program mode indicates how the digital program is being run,
characterized in that the apparatus further comprises:
obtaining means for obtaining an activating parameter from the application information, the activating parameter indicates the interactive application has at least two mutually different portions, at least one of the at least two portions is conditionally to be executed in dependency on the program mode.

14. A set-top box for activating an interactive application associated with a digital program comprising:
a receiver for receiving the digital program associated with the interactive application,
characterized in that the set-top box further comprises:
an activating apparatus for activating the interactive application associated with the digital program as claimed in claim 13.

15. A television set for activating an interactive application associated with a digital program comprising:
a receiver for receiving the digital program associated with the interactive application, and
a display for displaying the digital program,
characterized in that the television set further comprises:
an activating apparatus for activating the interactive application associated with the digital program as claimed in claim 13.

16. A digital recorder for storing a digital program and activating an application associated with the digital program comprising:
a receiver for receiving the digital program associated with the interactive application,
storing means for storing the digital program and conditionally storing the interactive application on a storage medium, and
retrieving means for retrieving the digital program associated with the interactive application from the storage medium.
characterized in that the digital recorder further comprises:
An activating apparatus for activating the interactive application associated with the digital program as claimed in claim 13.

17. A computer program product for activating an interactive application associated with a digital program, the computer program product comprising:
code for receiving program information of the digital program and application information regarding the interactive application,
code for detecting a program mode of the digital program, the program mode indicates how the digital program is being run,
characterized in that the computer program further comprises:
code for obtaining an activating parameter from the application information, the activating parameter indicates the interactive application has at least two mutually different portions, at least one of the at least two portions is conditionally to be executed in dependency on the program mode.

18. A storage carrier containing the computer program product as claimed in claim 17.

19. An interactive application associated to a digital program comprising:
at least two portions containing code,
code for detecting a program mode of the digital program, and
code for conditionally executing at least one portion of the application in dependency on the program code.
